(19) United States
(12) Patent Application Publication
(10) Pub. No.: US 2008/0091129 A1
(43) Pub. Date: Apr. 17, 2008

(54) Multi-function leg massaging device

(76) Inventor: Ko-Po Chen, Ta-Li City (TW)

Correspondence Address: PRO-TECHTOR INTERNATIONAL SERVICES, 20775 NORADA CT., SARATOGA, CA, 95070, US

(21) Appl. No.: 11/580,144

(22) Filed: Oct. 11, 2006

(51) Int. Cl. A61H 7/00

(52) U.S. Cl. 601/98; 601/99

(57) ABSTRACT

The present invention relates to a multi-function leg massaging device, which is used onto a massaging chair or can be a single massaging machine product, wherein the multi-function leg massaging device comprises a reciprocating displacement mechanism, a kneading mechanism and a pressing mechanism as well. The reciprocating displacement mechanism is provided with an inner frame having a drive source therein disposed onto an outer frame, by using the drive source, transmission sets respectively defined between each side of the transmitting shaft and the outer frame will be driven to actuate the inner frame to move reciprocatingly, and on the inner frame is mounted a kneading mechanism, also, by using the drive source of the inner frame, a rotary shaft having a plurality of eccentric sleeves will be driven, the respective eccentric sleeves is used to locate a swing arm so as to further fix a first massage member, and the pressing mechanism is provided on the rotary shaft with a plurality of second massage members, thus the different massage methods of the multi-function leg massaging device can be chosen based on the user's requirement so that the usage efficiency will be enhanced.

### BACKGROUND OF THE INVENTION

1. Field of the Invention

The present invention relates to a multi-function leg massaging device which is used onto a massaging chair or can be a single massaging machine product, thus the different massage methods of the multi-function leg massaging device can be chosen based on the user's requirement so that the usage efficiency will be enhanced.

2. Description of the Prior Arts

Referring to FIGS. 1-3, the Taiwan Application No. 91201841 discloses a leg massage and sport device comprising two recesses 12 formed on a main body 11 for holding the user's legs, a motor 13 mounted in the main body 11 for driving a rod 14, two ends of which is provided with a rotating member 15 so as to retain a belt 16, and at another end of the belt 16 being fitted onto a support member 17. In addition, a fixed portion 18 is disposed onto the belt 16 for locating a plurality of rollers 19 which extend into the respective recesses 12, a base 20 at the bottom of the main body 11 is provided with an air pump 21 for inflation of press members 22, wherein the press members 22 are fixed at the inner side of the recess 12 of the main body 11. While in use, the user can put his legs into the recesses 12, and then turns on the motor 13 so as to drive the rod 14 to rotate, such that the belt 16 will actuate a plurality of rollers 19 to cause a reciprocating displacement in the respective recesses 12, thereby the legs can be properly massaged. Also, the air pump 21 can be turn on for the air inflation or deflation such that the press members 22 can press or release the user's legs, however, such a conventional leg massage and sport device still has some defects as followings:

1. The press members 22 can merely used to press or release the user's legs by using the air inflation or deflation of the air pump 21, such a press and release massage method can only ease the user's muscle, but can not knead the acupuncture points of the legs, thus the massage effect is limited.

2. The rollers 19 can be used to reciprocatingly massage the user's legs, however, the press members 22 are fixedly defined onto the recesses 12 of the main body 11, respectively, hence only the massage at fixed points can be obtained instead of random massage of the legs.

3. Because the rollers 19 support gravity of the legs, the transmission mechanism relatively supports the same gravity, however, the rollers 19 must be maintained at a predetermined height so as to exert a predetermined force, but the belt 16 is a flexible member, hence, when the belt 16 bears gravity, it will be distorted to cause inwardly displacement of the rollers 19, thereby the pressing force of the rollers 19 will diminish.

The present invention has arisen to mitigate and/or obviate the afore-described disadvantages.

### SUMMARY OF THE INVENTION

The primary object of the present invention is to provide a multi-function leg massaging device, which is used onto a massaging chair or can be a single massaging machine product, wherein the multi-function leg massaging device comprises a reciprocating displacement mechanism, a kneading mechanism and a pressing mechanism as well. The reciprocating displacement mechanism is provided with an inner frame having a drive source therein disposed onto an outer frame, by using the drive source, transmission sets respectively defined between each side of the transmitting shaft and the outer frame will be driven to actuate the inner frame to move reciprocatingly, and on the inner frame is mounted a kneading mechanism, also, by using the drive source of the inner frame, a rotary shaft having a plurality of eccentric sleeves will be driven, the respective eccentric sleeves is used to locate a swing arm so as to further fix a first massage member, and the pressing mechanism is provided on the rotary shaft with a plurality of second massage members, thus the different massage methods of the multi-function leg massaging device can be chosen based on the user's requirement so that the usage efficiency will be enhanced.

The secondary object of the present invention is to provide a multi-function leg massaging device that the user can choose the kneading mechanism to massage both sides of two legs at fixed positions, by using the first massage member.

Further object of the present invention is to provide a multi-function leg massaging device that the user can choose the reciprocating displacement mechanism to actuate the kneading mechanism to reciprocatingly move so that the first massage member can convert the kneading massage motion of fixed points into the kneading massage motion of the both sides of two legs.

Another object of the present invention is to provide a multi-function leg massaging device that the user can choose the reciprocating displacement mechanism to actuate the pressing mechanism to reciprocatingly move so that the second massage member can massage the back side of the legs.

Still another object of the present invention is to provide a multi-function leg massaging device, an inner frame of which is used to mount the kneading mechanism and the pressing mechanism, and the rigid transmission set (such as a gear and rack set) is defined between each side of the transmitting shaft and the outer frame for having a better support force, thereby the kneading mechanism and the first and the second massage member of the pressing mechanism can maintain at a specific position and can exert a predetermined massaging force to massage the legs, when the transmission set bears gravities of legs.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of the Taiwan Application No. 91201841;

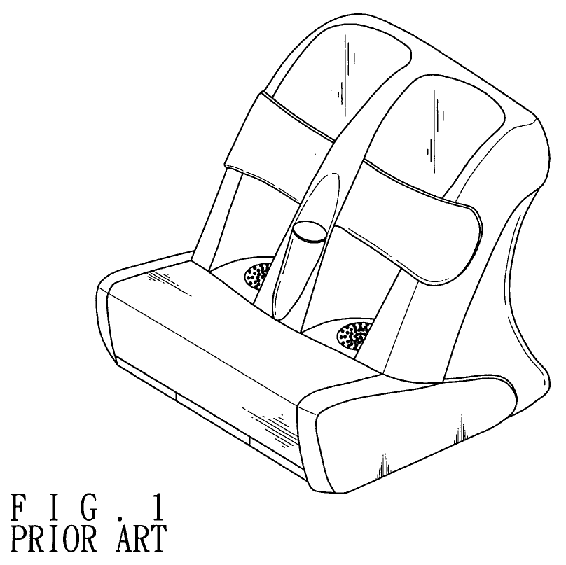

FIG. 2 is a top plan view of the Taiwan Application No. 91201841;

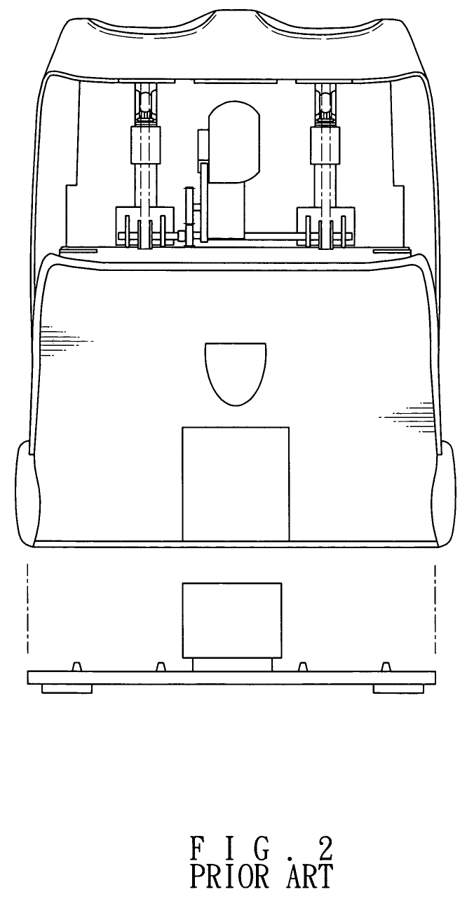

FIG. 3 is a bottom plan view of the Taiwan Application No. 91201841;

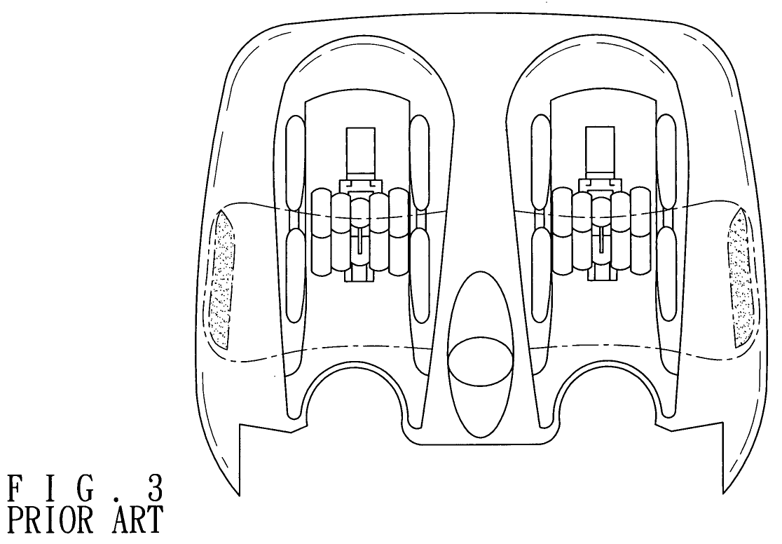

FIG. 4 is a perspective view of a multi-function leg massaging device in accordance with the present invention;

FIG. 5 is a top plan view of the multi-function leg massaging device in accordance with the present invention;

FIG. 6 is a front elevation view of the multi-function leg massaging device in accordance with the present invention;

FIG. 7 shows the multi-function leg massaging device of the present invention used to be a single massaging machine product;

FIG. 8 shows a top plan view of the multi-function leg massaging device of the present invention used to knead and press the user's legs at fixed positions;

FIG. 9 is an operational view of a kneading mechanism of the multi-function leg massaging device of the present invention;

FIG. 10 shows the multi-function leg massaging device of the present invention reciprocatingly moving to knead and press the user's legs;

FIG. 11 shows the multi-function leg massaging device of the present invention adapted for an electric massage chair.

### DETAILED DESCRIPTION OF THE PREFERRED EMBODIMENT

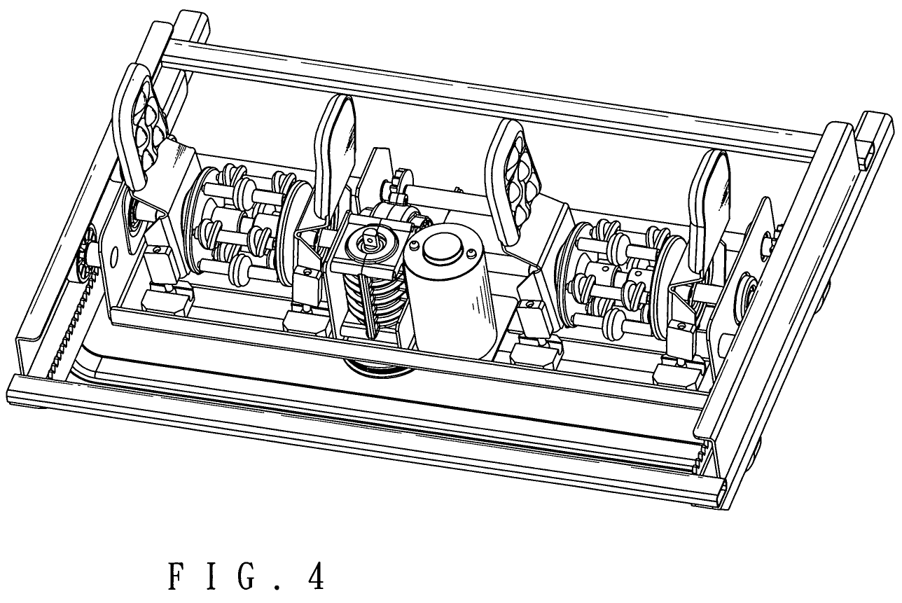

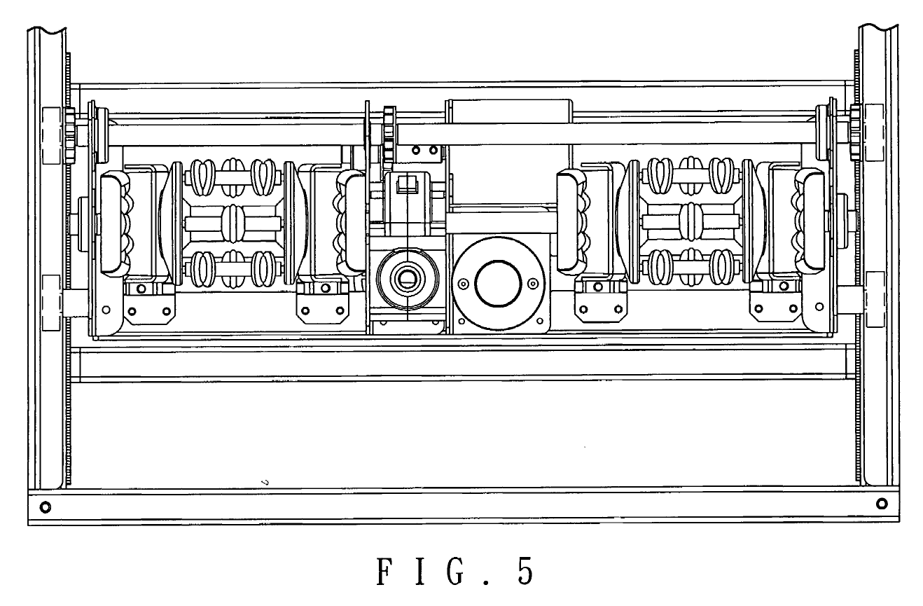

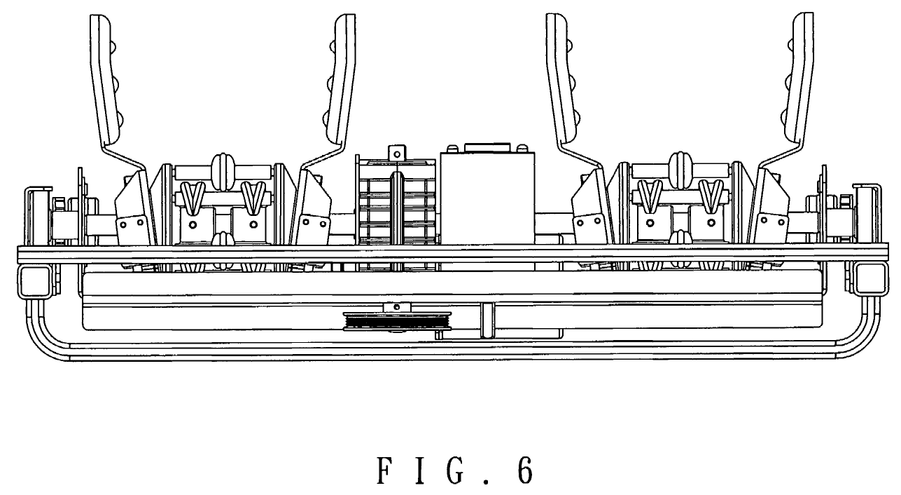

Referring to FIGS. 4-6, a multi-function leg massaging device 3 in accordance with the present invention is shown and comprises a reciprocating displacement mechanism 31, a kneading mechanism 33 and a pressing mechanism 34 as well, wherein the reciprocating displacement mechanism 31 is provided at each side of an outer frame 311 with a rail 312 and is defined onto the outer frame 311 with an inner frame 313 having a motor 314, by using a gear set 315 of a first transmission set, the motor 314 can drive a transmitting shaft 316, and between each side of the transmitting shaft 316 and the outer frame 311 is disposed a second transmission set and a first roller 317, wherein said second transmission set is provided at each side of the transmitting shaft 316 with a gear 318, and at the outer frame 311 is mounted a rack 319 for meshing with the gear 318 such that the inner frame 313 can be actuated to cause a reciprocating movement on the outer frame 311, during the gear 318 reciprocatingly moves on the racks 319. Furthermore, at each outer side of the inner frame 313 is arranged a second roller 320, wherein the first roller 317 and said second roller 320 are both slidably located on the rail 312 of the outer frame 311 for auxiliarily causing the reciprocating displacement of the inner frame 313 on which is mounted the kneading mechanism 33, by using a motor 331, said kneading mechanism 33 can drive a rotary shaft 333 having a plurality of eccentric sleeves 334 thereon to rotate through a gear box 332, wherein the respective eccentric sleeves 334 is used to locate a swing arm 335 so as to further fix a first massage member 336 having a plurality of massage projections thereon, and at front side of the swing arm 335 is formed a confining assembly 337 for the prevention of the rotation of swing arm 335 and the first massage member 336 such that the two corresponding first massage members 336 can disengage from or engage with each other by means of the respective eccentric sleeves 334, thus the massage motions can be achieved. The pressing mechanism 34 is provided on the rotary shaft 333 with a plurality of second massage members 341 (such as rollers), wherein the respective second massage members 341 can simultaneously rotate with the rotation of the rotary shaft 333 so as to massage the user's legs.

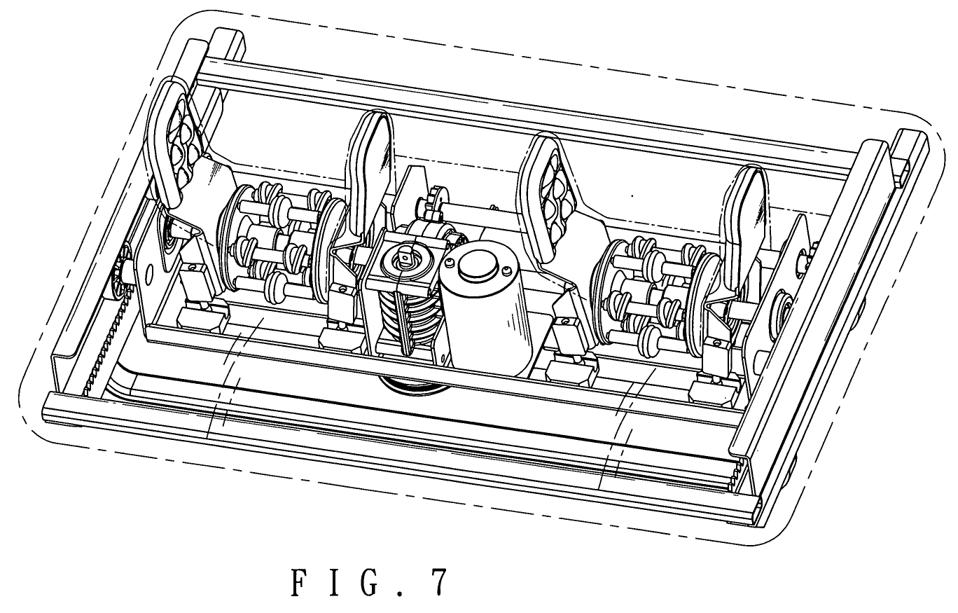

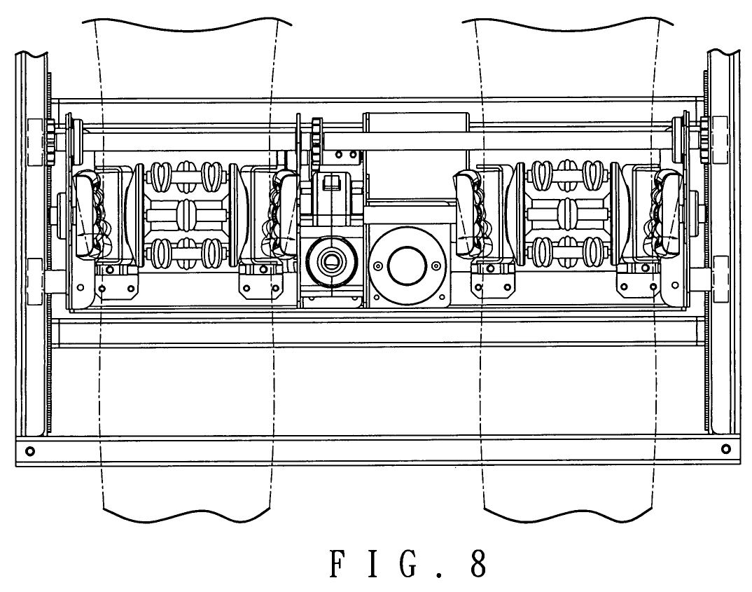

Referring further to FIGS. 7-9, the multi-function leg massaging device 3 in accordance with the present invention can be a single massaging machine product, wherein the user can respectively put his legs between the two respective corresponding first massage members 336 and then let his legs abut against the second massage members 341, after turning on the motor 331 of the kneading mechanism 33, the rotary shaft 333 will actuate the first massage members 336 and the second massage members 341 of the pressing mechanism 34 to simultaneously rotate, wherein when said first massage members 336 of the kneading mechanism 33 rotate, the eccentric sleeves 334 will alternately disengage from or engage with each other so as to have a fixed-position massage of both sides of legs such as an acupuncture-pointed massage, and the second massage members 341 of the pressing mechanism 34 will also simultaneously rotate to massage the back side of the legs such as a muscle-pressed and acupuncture-pointed massage, thereby enabling to enhance the usage efficiency of the multi-function leg massaging device.

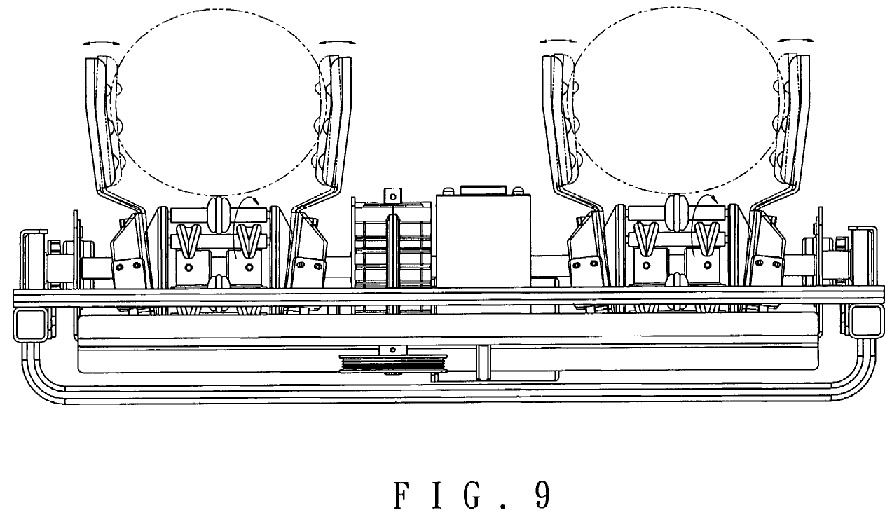

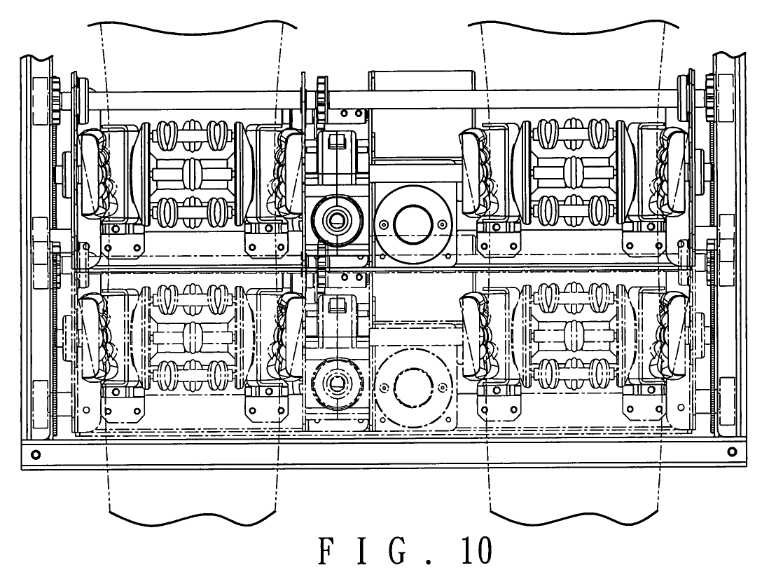

Referring further to FIGS. 9-10, the multi-function leg massaging device 3 in accordance with the present invention can provide the user to optionally change massage methods, wherein when turning on the motor 314 of the reciprocating displacement mechanism 31 and the motor 331 of the kneading mechanism 33, the motor 314 will drive the transmitting shaft 316 through the gear set 315 such that the gear 318 of each side of the transmitting shaft 316 will move along the rack 319 of the outer frame 311, and by using the rolling of the first roller 317 and the second roller 320, the inner frame 313, the kneading mechanism 33 and the pressing mechanism 34 will reciprocatingly move so as to expend the massaging range of the kneading mechanism 33 and the pressing mechanism 34. When the motor 331 of the kneading mechanism 33 drives the rotary shaft 333 to actuate the first massage members 336 and the second massage members 341 of the pressing mechanism 34 to simultaneously move, said first massage members 336 can be changeably to knead the legs, and by means of the movement of the reciprocating displacement mechanism 31, the first massage members 336 will be changed to cause rubbing motions so as to massage both sides of the legs, also, by using the movement of the reciprocating displacement mechanism 31, the second massage members 341 of the pressing mechanism 34 will simultaneously massage the back side of the legs, thus the rubbing massage and the pressing massage can both be obtained.

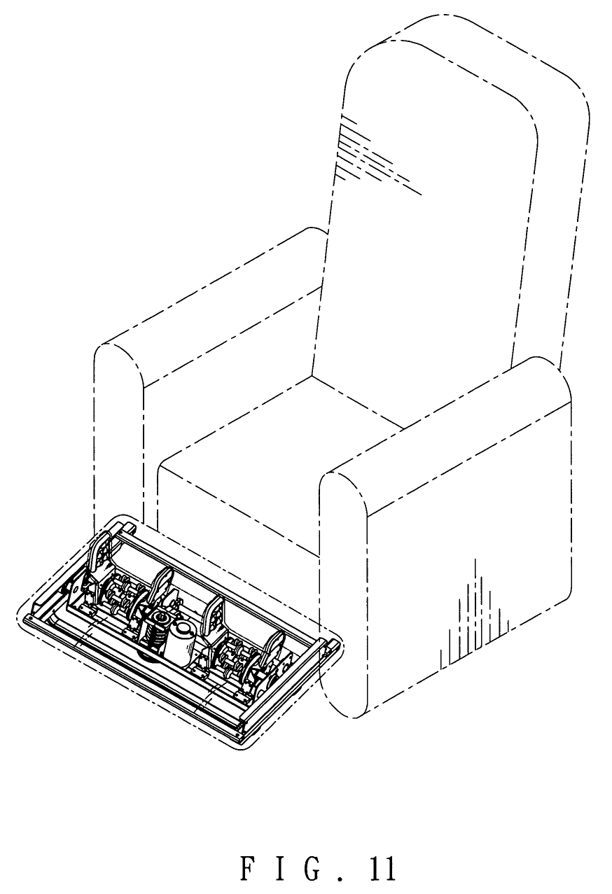

As shown in the FIG. 11, a multi-function leg massaging device 3 of the present invention can be applied onto an electric massage chair, wherein a massaging device 3 comprises two pivoting holes 321 respectively formed at two sides of the outer frame 311, by using said two pivoting holes 321, the massaging device 3 can be pivotally disposed to an electric massage chair 4, thus a leg massaging device can be achieved. While in use, the user can put his legs between the two respective corresponding first massage members 336 and let his legs abut against the second massage members 341, then the user can apply the first massage members 336 and the second massage members 341 to fixedly knead and press two sides of his legs and the back side thereof. Moreover, by using the reciprocating displacement mechanism 31, the kneading mechanism 33 and the pressing mechanism 31, the first massage members 336 and the second massage members 341 can reciprocatingly rub and press two sides of the user's legs and the back side thereof, hence, the different massage methods of the massaging device can be obtained.

While we have shown and described various embodiments in accordance with the present invention, it should be clear to those skilled in the art that further embodiments may be made without departing from the scope of the present invention.

What is claimed is:

1. A multi-function leg massaging device comprises:
a reciprocating displacement mechanism provided with an outer frame and an inner frame, on the inner frame being disposed a transmitting shaft driven by a drive source, between each side of said transmitting shaft and the outer frame being defined with a transmission set for actuating the inner frame to reciprocatingly move on the outer frame;
a kneading mechanism having a rotary shaft driven by a drive source mounted onto the inner frame of the reciprocating displacement mechanism, and by using a swing arm, a plurality of eccentric massage members being respectively arranged on the rotary shaft for massaging the user's legs.

2. The multi-function leg massaging device as claimed in claim 1, wherein the drive source of the reciprocating displacement mechanism is a motor, by using a first transmission set, the motor can drive the transmitting shaft.

3. The multi-function leg massaging device as claimed in claim 1, wherein the transmission set of the reciprocating displacement mechanism is a second transmission set provided at each side of the transmitting shaft with a gear, and on the outer frame is defined with a rack meshing with the gear.

4. The multi-function leg massaging device as claimed in claims 1, wherein a rail is disposed on the outer frame of the reciprocating displacement mechanism for slidably locating a roller of each side of the inner frame.

5. The multi-function leg massaging device as claimed in claims 1, wherein the drive source of the kneading mechanism is a motor so as to drive the rotary shaft through a gear box.

6. The multi-function leg massaging device as claimed in claim 1, wherein the kneading mechanism is provided on the rotary shaft with a plurality of eccentric sleeves, each can be used to locate a swing arm having a massage member thereon, the massage member is a first massage member defined with a plurality of massaging projections for changeably alternate massage.

7. The multi-function leg massaging device as claimed in claim 1, wherein at front side of the swing arm of the kneading mechanism is formed a confining assembly so that the two corresponding first massage members can disengage from or engage with each other.

8. The multi-function leg massaging device as claimed in claim 1, wherein a pressing mechanism is used to press the user's legs.

9. The multi-function leg massaging device as claimed in claim 8, wherein the pressing mechanism is provided on the rotary shaft with at least one second massage member driven by the drive source of the kneading mechanism.

10. A multi-function leg massaging device comprises:
a reciprocating displacement mechanism provided with an outer frame and an inner frame, the outer frame pivotally connecting onto a massaging chair, and on the inner frame being disposed a transmitting shaft driven by a drive source, between each side of said transmitting shaft and the outer frame being defined with a transmission set for actuating the inner frame to reciprocatingly move on the outer frame;
a kneading mechanism having a rotary shaft driven by a drive source mounted onto the inner frame of the reciprocating displacement mechanism, and by using a swing arm, a plurality of eccentric massage members being respectively arranged on the rotary shaft for massaging the user's legs.

11. The multi-function leg massaging device as claimed in claim 10, wherein the drive source of the reciprocating displacement mechanism is a motor, by using a first transmission set, the motor can drive the transmitting shaft.

12. The multi-function leg massaging device as claimed in claim 10, wherein the transmission set of the reciprocating displacement mechanism is a second transmission set provided at each side of the transmitting shaft with a gear, and on the outer frame is defined with a rack meshing with the gear.

13. The multi-function leg massaging device as claimed in claims 10, wherein a rail is disposed on the outer frame of the reciprocating displacement mechanism for slidably locating a roller of each side of the inner frame.

14. The multi-function leg massaging device as claimed in claims 10, wherein two pivoting holes respectively formed at two sides of the outer frame for pivotally disposing the massaging device to a massage chair.

15. The multi-function leg massaging device as claimed in claims 10, wherein the drive source of the kneading mechanism is a motor so as to drive the rotary shaft through a gear box.

16. The multi-function leg massaging device as claimed in claim 10, wherein the kneading mechanism is provided on the rotary shaft with a plurality of eccentric sleeves, each can be used to locate a swing arm having a massage member thereon, the massage member is a first massage member defined with a plurality of massaging projections for changeably alternate massage.

17. The multi-function leg massaging device as claimed in claim 10, wherein at front side of the swing arm of the kneading mechanism is formed a confining assembly so that the two corresponding first massage members can disengage from or engage with each other.

18. The multi-function leg massaging device as claimed in claim 10, wherein a pressing mechanism is used to press the user's legs.

19. The multi-function leg massaging device as claimed in claim 18, wherein the pressing mechanism is provided on the rotary shaft with at least one second massage member driven by the drive source of the kneading mechanism.
